(19) United States
(12) Patent Application Publication
(10) Pub. No.: US 2005/0007375 A1
(43) Pub. Date: Jan. 13, 2005

(54) Seamless image processing method and apparatus

(75) Inventor: Jong-hyon Yi, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd, Suwon-si (KR)

(21) Appl. No.: 10/880,469

(22) Filed: Jul. 1, 2004

(30) Foreign Application Priority Data
Jul. 9, 2003 (KR) 2003-46319

(51) Int. Cl. G06F 13/00

(52) U.S. Cl. 345/537

(57) ABSTRACT

A seamless image processing apparatus and method, the apparatus includes a first storage unit, storing original image data, the original image data including lines arranged in a vertical direction and pixels arranged in each of the lines in a horizontal direction, and a signal processing unit receiving blocks, in which the original image data stored in the first storage unit is divided, based on a digital memory access and performing image processing on each of the blocks of each of the lines using main data and first and second overlap data so that no seams are generated at a boundary between adjacent blocks. Accordingly, image processing is performed on a current block using data resulting from image processing performed on the previous block and image data included in the next block. Thus, seams between adjacent blocks do not appear.

### CROSS-REFERENCE TO RELATED APPLICATION

This application claims the benefit of Korean Patent Application No. 2003-46319, filed on Jul. 9, 2003, in the Korean Intellectual Property Office, the disclosure of which is incorporated herein by reference.

### BACKGROUND OF THE INVENTION

1. Field of the Invention

The present invention relates to an image forming system, and more particularly, to an image processing method and apparatus in which large image data is divided into a predetermined number of blocks and image processing is performed on the divided blocks producing a visually contiguous image without seams between adjacent blocks.

2. Description of the Related Art

In image processing apparatuses, if an original image stored in an external memory has many pixels in a horizontal or vertical direction, it is impossible to store image data corresponding to a single horizontal or vertical line of the original image in a local memory having a restricted capacity. Hence, the original image is divided into blocks in the horizontal or vertical direction, and the divided blocks are stored in the local memory and undergo image processing. Examples of the image processing include image processing that uses only an interest pixel, such as, color transformation, enlargement/reduction, or noise removal, and image processing that uses a neighborhood around an interest pixel, such as, masking, error diffusion, or segmentation/enhancement. The image processing that uses only an interest pixel does not cause a problem relating to a seam between adjacent blocks. However, the image processing that uses a neighborhood around an interest pixel may cause a seam problem.

For example, when N×N masking is performed using blocks of N pixels in the horizontal direction by N pixels in the vertical direction that include an interest pixel, if the interest pixel is located near the boundary between adjacent blocks, an image obtained by the N×N masking includes a seam between the adjacent blocks. In other words, if the interest pixel is on a left side of the boundary between adjacent blocks, upper, lower, and right pixel values of the interest pixel can be obtained from a local memory, but a left pixel value cannot. If the interest pixel is on a right side of the boundary between adjacent blocks, upper, lower, and left pixel values can be obtained from the local memory, but a right pixel value cannot. Hence, an image resulting from the masking is not natural and appears unpleasant to the eye at the boundary between the adjacent blocks.

Also, in the case of error diffusion in which an output value of an interest pixel is calculated using an accumulated error value, an interest pixel included in a block and located near the boundary between the block and a neighboring block cannot refer to information regarding pixels included in the neighboring block. Thus, a seam is generated between adjacent blocks, and an image obtained by the result of error diffusion is not natural and appears unpleasant to the eye.

### SUMMARY OF THE INVENTION

The present invention provides an image processing method and an image processing apparatus, in which image data having many pixels in a horizontal or vertical direction is divided into a predetermined number of blocks and image processing is performed on the divided blocks using a local memory with a restricted capacity, producing a visually contiguous image without seams between adjacent blocks.

According to an aspect of the present invention, there is provided a seamless image processing apparatus including a first storage unit, storing original image data, having lines arranged in a vertical direction and blocks arranged in each of the lines in a horizontal direction; and a signal processing unit, receiving the blocks, into which the original image data stored in the first storage unit is divided, based on a digital memory access and performs image processing on each of the blocks of each of the lines using main data and first and second overlap data so that no seams are generated at a boundary between adjacent blocks.

According to another aspect of the present invention, the signal processing unit includes a second storage unit, storing the main data and the first and second overlap data of a current block; a digital memory access controller, which controls transmission of data between the first and second storage units; an image processor, which performs image processing using the original image data and the first and second overlap data stored in the second storage unit; a third storage unit, which stores data resulting from image processing performed on the current block by the image processor as the first overlap data for performing image processing on a next block; and an overlap controller, dividing the second storage unit into a plurality of areas and controlling the digital memory access controller and the image processor so that image data is transmitted from the first and third storage units to the areas of the second storage unit.

According to another aspect of the present invention, the signal processing unit includes a second storage unit, storing the main data, the first and second overlap data of a current block, and data resulting from image processing on the current block; a digital memory access controller, controlling transmission of data between the first and second storage units; an image processor using the original image data and the first and second overlap data stored in the second storage unit to generate first overlap data for performing image processing on a next block; and an overlap controller dividing the second storage unit into a plurality of areas and controlling the digital memory access controller and the image processor so that image data is transmitted from the first storage unit to the areas of the second storage unit.

According to another aspect of the present invention, there is provided a seamless image processing method including determining a transmission size based on a digital memory access and an overlap data size; dividing original image data into N blocks according to the transmission size and the overlap data size and storing main data, first and second overlap data, and data resulting from image processing on a block-by-block basis, wherein the main data, the first and second overlap data, and the data resulting from image processing correspond to each of the blocks of each of the lines; and performing image processing on a current block and generating first overlap data for a next block.

According to another aspect of the present invention, the operation of dividing the original image data into N blocks includes loading main data of the current block among the original image data and loading at least one of the first and second overlap data depending on the location of the current block in each of the lines.

According to another aspect of the present invention, the loading of the at least one of the first and second overlap data includes loading second overlap data located close to the current block from the next block if the current block is the first block; loading first overlap data located close to the current block among data resulting from image processing on the previous block and second overlap data located close to the current block among the data included in the next block, if the current block is one of second through (N−1)th blocks; and loading first overlap data located close to the current block among the data resulting from image processing on the previous block if the current block is the N-th block.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other features and advantages of the present invention will become more apparent and more readily appreciated by describing in detail exemplary embodiments thereof with reference to the attached drawings in which:

FIG. 1 is a block diagram of an image processing apparatus according to a first embodiment of the present invention;

FIG. 2 illustrates a sequence of image processing performed by an image processor of FIG. 1;

FIG. 3 illustrates overlap data required during image processing on each of N blocks of FIG. 2;

FIG. 4 illustrates data allocation of a second storage unit of FIG. 1;

FIG. 5 illustrates a division of areas of the second storage unit according to locations of blocks, and types of data stored in a third storage unit of FIG. 4;

FIG. 6 is a block diagram of an image processing apparatus according to a second exemplary embodiment of the present invention;

FIG. 7 illustrates data allocation of a second storage unit of FIG. 6;

FIG. 8 illustrates types of data stored in the second storage unit of FIG. 7; and

FIG. 9 is a flowchart illustrating a method of loading image data to perform image processing according to an exemplary embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

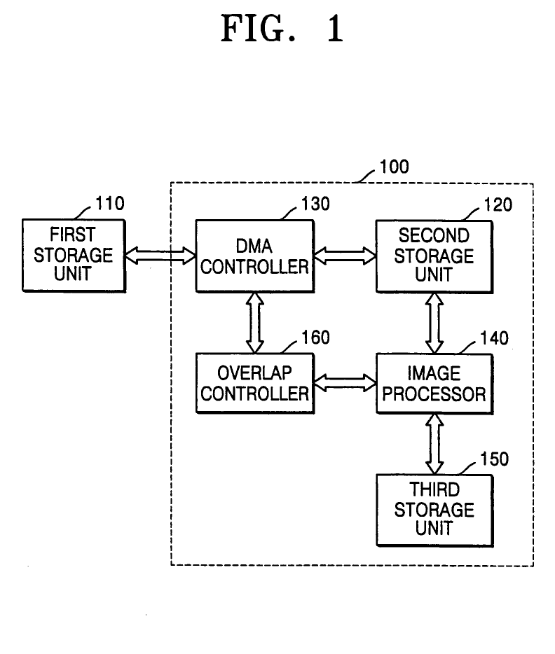

FIG. 1 is a block diagram of an image processing apparatus according to a first exemplary embodiment of the present invention. The image processing apparatus includes a first storage unit 110 and a signal processing unit 100, which includes a second storage unit 120, a direct memory access (DMA) controller 130, an image processor 140, a third storage unit 150, and an overlap controller 160.

Referring to FIG. 1, the first storage unit 110 is a large-capacity memory and stores original image data. The second storage unit 120 is a small-capacity and high-speed memory. The original image data made of P lines arranged in the vertical direction and (k×N) pixels, included in each of the P lines, and is divided into N blocks in the horizontal direction. With respect to each of the N blocks included in each of the P lines, its main data and first and second overlap data are stored in the second storage unit 120. The DMA controller 130 controls data transmission and reception between the first and second storage units 110 and 120. In most digital signal processors (DSPs), it is difficult for the access speed of a large-capacity memory to follow an enhanced processing speed of a logic circuit. Hence, the first storage unit 110, which is a large-capacity memory, is not directly connected to the image processor 140. Instead, the second storage unit 120, which is a small-capacity and high-speed memory, is connected to the image processor 140.

The image processor 140, which is a DSP, performs image processing, such as masking, segmentation/enhancement, or error diffusion, on a pixel-by-pixel basis using main data and first and second overlap data stored in the second storage unit 120. Processed data resulting from the image processing performed on the main data of a current block by the image processor 140 is transmitted to a next stage (not shown). Data located in a predetermined region of the processed data of the current block is stored in the third storage unit 150 and used as the first overlap data when the next block is image-processed.

The overlap controller 160 determines a DMA-based transmission size and an overlap size and sets a plurality of addresses in the second storage unit 120 for storing the main data and the first and second overlap data based on the determined DMA-based transmission size and the determined overlap size. The DMA-based transmission size is determined according to the capacity of the second storage unit 120, and the overlap size is determined according to the type of image processing performed by the image processor 140. If the image processor 140 performs 5×5 masking, the overlap size corresponds to two pixels. If original image data is divided into N blocks based on the DMA-based transmission size, the overlap controller 160 controls the image processor 140 so that data resulting from image processing on a previous block, which is stored in the third storage unit 150, is stored as the first overlap data in the set addresses of the second storage unit 120. Also, the overlap controller 160 transmits a transmission start command to the DMA controller 130 so that the main data in the current block in each line and the second overlap data in a next block are transmitted from the first storage unit 110 to the second storage unit 120 on a block-by-block basis in a predetermined sequence. Transmission start commands for the N blocks in each line are sequentially transmitted, and each is transmitted at a moment when the image processor 140 finishes image processing of a previous block on a given line, with a first block of a line being transmitted when image processing on a last block of a previous line is finished.

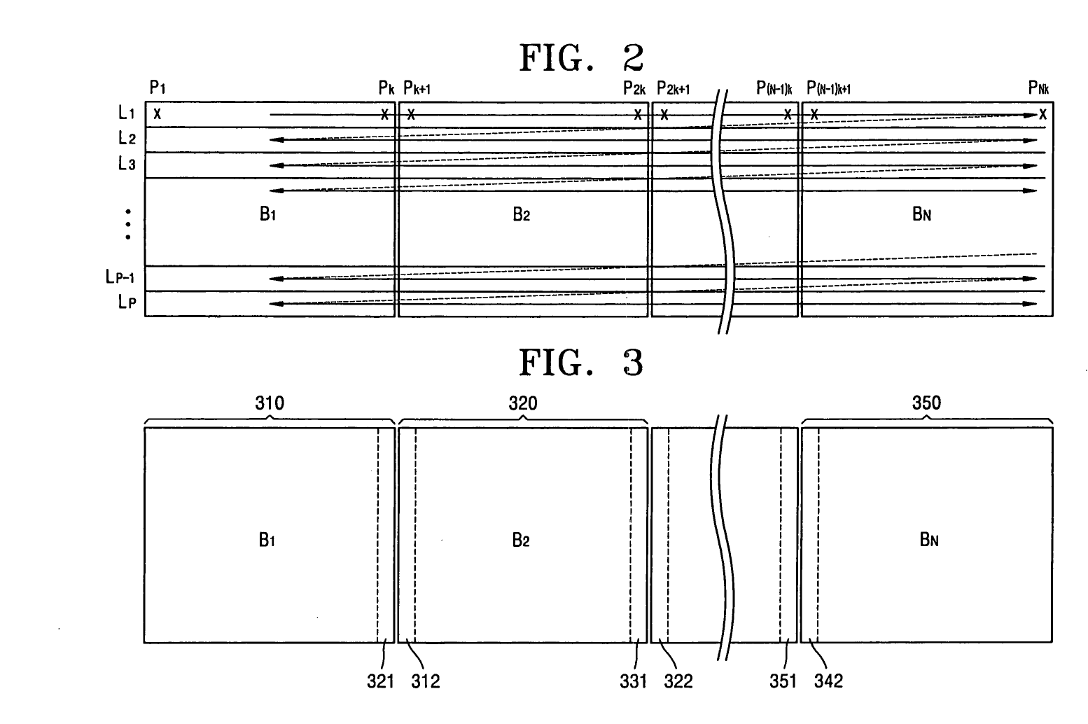

FIG. 2 illustrates the sequence of image processing performed by the image processor 140 of FIG. 1. The original image data shown in FIG. 2 includes P lines in a vertical direction, each line having (k×N) pixels, and divided into N blocks.

Referring to FIG. 2, the image processor 140 performs image processing on a line-by-line basis, and within each of the lines, image processing is performed on a block-by-block basis. In a first line L₁, pixels are processed in the sequence of k pixels P₁ through Pₖ in a first block B₁, k pixels Pₖ₊₁ through P₂ₖ in a second block B₂, . . . , and k pixels P₍ₙ₋₁₎ₖ₊₁ through Pₙₖ in an N-th block B_{N}. This process is applied to each consecutive line. Accordingly, in the last line Lₚ, pixels are processed in the sequence of k pixels P₁ through Pₖ in the first block B₁, k pixels Pₖ₊₁ through P₂ₖ in the second block B₂, . . . , and k pixels P₍ₙ₋₁₎ₖ₊₁ through Pₙₖ in the N-th block B_{N}.

FIG. 3 illustrates image data required during image processing of each of the N blocks of FIG. 2. When the first block B₁ of each line is processed, its previous block does not exist, and accordingly, only second overlap data 312, which is included in the second block B₂ and located near the boundary between the first and second blocks B₁ and B₂, is used with main data 310 without first overlap data. In other words, pixels among the main data 310 of the first block B₁, that are adjacent to the second block B₂ are processed using the second overlap data 312 and if necessary, temporary data.

The second block B₂ is processed using three types of data, namely, first overlap data 321, main data 320, and second overlap data 322. The first overlap data 321 resulting from image processing of the first block B₁ is located near the boundary between the first and second blocks B₁ and B₂. The second overlap data 322 is included in the third block B₃ and located near the boundary between the second and third blocks B₂ and B₃. In other words, pixels among main data of each of the second through (N−1)th blocks B₂ through B_{N-1} that are adjacent to a previous block are processed using first overlap data and necessary temporary data. Pixels among main data of each of the second through (N−1)th blocks B₂ through B_{N-1} that are adjacent to a subsequent block are processed using second overlap data and necessary temporary data.

The N-th block B_{N} is processed using first overlap data 351 and main data 350. The first overlap data 351 is located at the boundary between the (N−1)th and N-th blocks B_{N-1} and B_{N} among data resulting from image processing on the (N−1)th blocks B_{N-1}. In other words, pixels adjacent to the (N−1)th block B_{N-1} among the main data 350 of the N-th block B_{N} are processed using the first overlap data 351 and necessary temporary data.

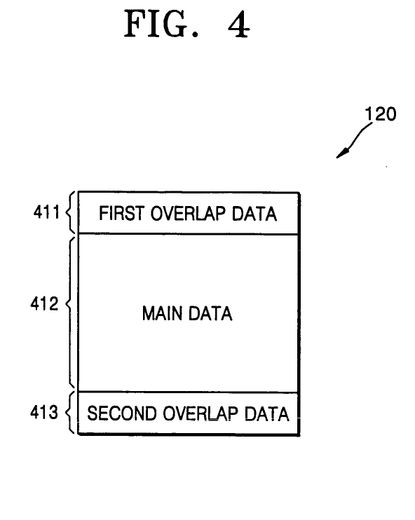

FIG. 4 illustrates data allocation of the second storage unit 120 of FIG. 1. The second storage unit 120 includes a first area 411, which stores first overlap data of a previous block, a second area 412, which stores main data of a current block, and a third area 413, which stores second overlap data of a next block. The first overlap data is data located at the boundary between the current and previous blocks, among data corresponding to the result of image processing of the previous block. The second overlap data is data included in the next block located near the boundary between the current and next blocks. The overlap controller 160 receives the first overlap data from the third storage unit 150 via the image processor 140, and the overlap controller 160 receives the second overlap data from the first storage unit 110 via the DMA controller 130.

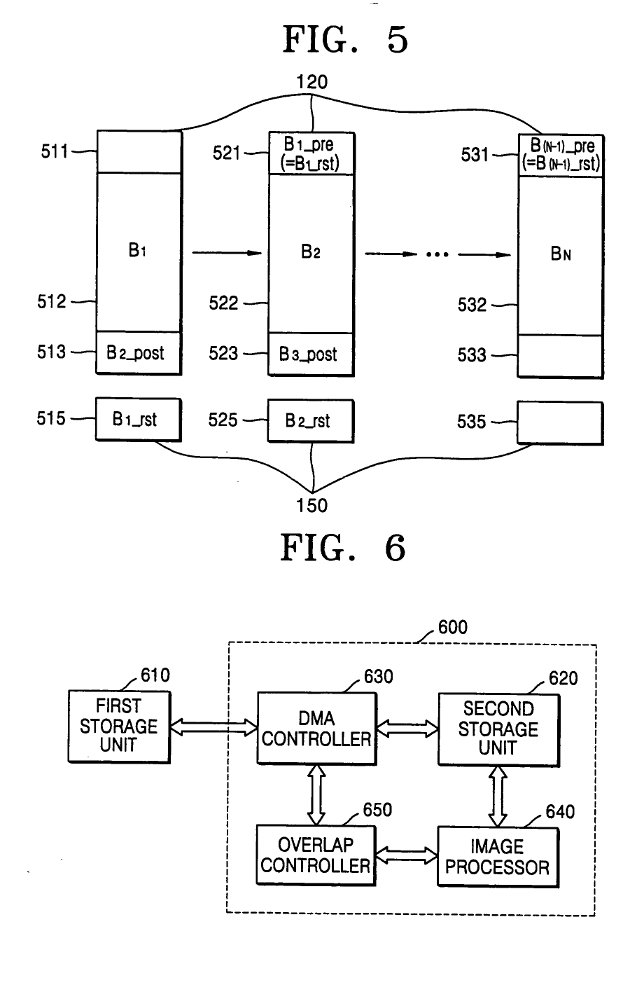

FIG. 5 shows a division of the areas 411, 412, and 413 of the second storage unit 120 of FIG. 4 according to the locations of blocks, and the types of data stored in the third storage unit 150. Referring to FIG. 5, the second storage unit 120 is divided into first, second, and third areas 511, 512, and 513 and the third storage unit 150 includes the fourth area 515. First, second, and third areas 511, 512, and 513 are allocated for the second block B₁. The first area 511 is set with a default value, the second area 512 stores the main data of the first block B₁, and the third area 513 stores second overlap data B₂_{_{—}}ₚₒₛₜ, which is located in the second block B₂. The fourth area 515 stores boundary data B₁_{_{—}}ᵣₛₜ located at the boundary between the first and second blocks B₁ and B₂ resulting from image processing of the first block B₁.

First, second, and third areas 521, 522, and 523 are allocated for the second block B₂. The first area 521 stores data B₁_{_{—}}ₚᵣₑ, which is equivalent to the boundary data B₁_{_{—}}ᵣₛₜ, the second area 522 stores the main data of the second block B₂, and the third area 523 stores second overlap data B₃_{_{—}}ₚₒₛₜ, which is located in the third block B₃. The fourth area 525 stores boundary data B₂_{_{—}}ᵣₛₜ located at the boundary between the second and third blocks B₂ and B₃ resulting from image processing of the second block B₂. The data storage of first, second, and third areas of third through (N−1)th blocks B₃ through B_{N-1} is equivalent to the data storage of the first, second, and third areas 521, 522, and 523 of the second block B₂.

Also, first, second, and third areas 531, 532, and 533 are allocated for the N-th block B_{N}. The first area 531 stores data B_{(N-1)}_{_{—}}ₚᵣₑ regarding the (N−1)th block B_{N-1}, the second area 532 stores the main data of the N-th block B_{N}, and the third area 533 is set with a predetermined default value. The fourth area 535 is also set with a predetermined default value.

FIG. 6 is a block diagram of an image processing apparatus according to a second exemplary embodiment of the present invention, which includes a first storage unit 610 and a signal processing unit 600. The signal processing unit 600 includes a second storage unit 620, a DMA controller 630, an image processor 640, and an overlap controller 650. The second embodiment of FIG. 6 is equivalent to the first embodiment of FIG. 1 except that the third storage unit 150 is removed and a fourth area is further included in the second storage unit 620.

Referring to FIG. 6, the first storage unit 610 stores original image data. The original image data is made of P lines arranged in a vertical direction and (k×N) pixels arranged in a horizontal direction in each of the P lines. The original image data is further divided into N blocks in the horizontal direction. The second storage unit 620 stores main data and first and second overlap data, with respect to each of the N blocks included in each of the P lines and data resulting from image processing of the main data of the current block that is used for image processing of the next block. The DMA controller 630 controls data transmission and reception between the first and second storage units 610 and 620.

The image processor 640 performs image processing on a pixel-by-pixel basis using the main data and first and second overlap data stored in the second storage unit 620. Processed data resulting from the image processing performed on the main data of the current block by the image processor 640 is transmitted to a next stage (not shown). Processed, data located adjacent to the next block is stored in a predetermined area of the second storage unit 620 and used as first overlap data when the next block is image-processed.

The overlap controller 650 determines a DMA-based transmission size and an overlap size. According to the determined DMA-based transmission size and the determined overlap size, the overlap controller 650 sets a plurality of addresses in the second storage unit 620 for storing main data, first and second overlap data, and data resulting from image processing. If original image data is divided into N blocks based on the DMA-based transmission size, the overlap controller 650 controls the image processor 640 so that the processed data resulting from image processing performed on a previous block, which is stored in the second storage unit 620, is stored as first overlap data in a predetermined area of the second storage unit 620. Also, the overlap controller 650 transmits a transmission start command to the DMA controller 630 so that the main data of the current block in each line and second overlap data in the next block are transmitted from the first storage unit 610 to the second storage unit 620 on a block-by-block basis in a predetermined sequence.

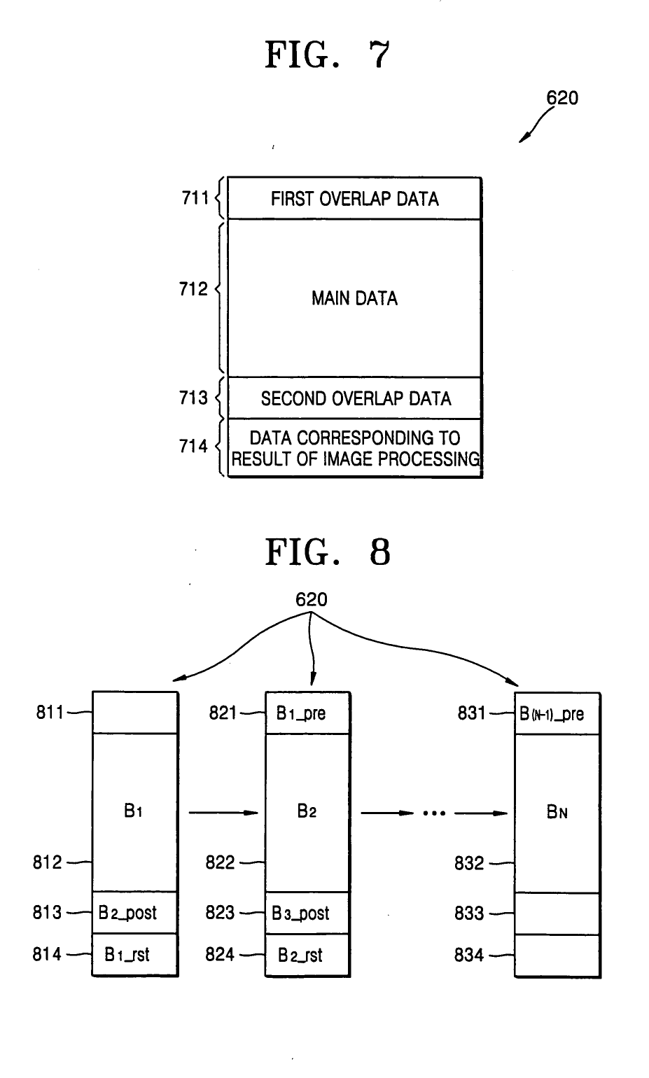

FIG. 7 illustrates data allocation of the second storage unit 620 of FIG. 6. The second storage unit 620 includes first through fourth areas 711, 712, 713 and 714. The first area 711 stores first overlap data located in a previous block. The second area 712 stores main data of a current block. The third area 713 stores second overlap data located in a next block. The fourth area 714 stores data located adjacent to the next block resulting from the image processing performed on the main data of the current block and the data is used as first overlap data for performing image processing on a next block. The first overlap data is data located around the boundary between the current and previous blocks resulting from image processing performed on the previous block. The second overlap data is data located near the boundary between the current and next blocks. The overlap controller 650 receives the first overlap data from the fourth area 714 of the second storage unit 620 via the image processor 640, and the overlap controller 650 receives the second overlap data from the first storage unit 610 via the DMA controller 630.

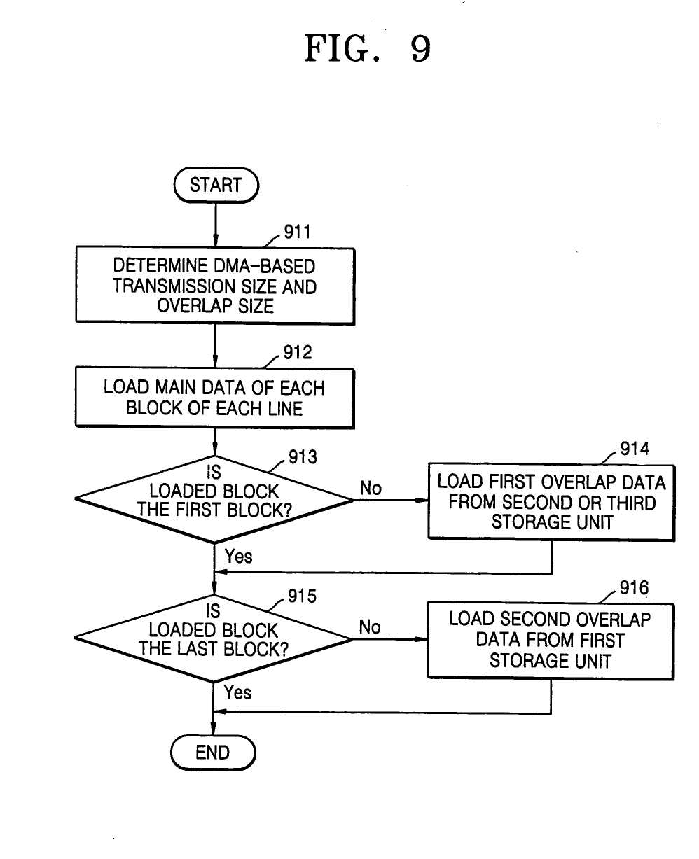

FIG. 8 illustrates a division of the areas 711, 712, 713, and 714 of the second storage unit 620 of FIG. 7 according to block locations. Referring to FIG. 8, first, second, third, and fourth areas 811, 812, 813, and 814 are allocated for the first block B₁. The first area 811 is set with a default value, the second area 812 stores the main data of the first block B₁, the third area 813 stores second overlap data B₂_{_{—}}ₚₒₛₜ, from the second block B₂, and the fourth area 814 stores boundary data B₁_{_{—}}ᵣₛₜ, located near the boundary between the first and second blocks B₁ and B₂ resulting from image processing performed on the first block B₁.

First, second, third, and fourth areas 821, 822, 823, and 824 are allocated to the second block B₂. The first area 821 stores data B₁_{_{—}}ₚᵣₑ, which is equivalent to the boundary data B₁_{_{—}}ᵣₛₜ, the second area 822 stores the main data of the second block B₂, the third area 823 stores second overlap data B₃_{_{—}}ₚₒₛₜ, from the third block B₃, and the fourth storage area 824 stores boundary data B₂_{_{—}}ᵣₛₜ located around the boundary between the second and third blocks B₂ and B₃ resulting from image processing performed on the second block B₂. The data storage of first, second, third, and fourth areas of third through (N−1)th blocks B₃ through B_{N-1} are equivalent to the data storage of the first, second, third, and fourth areas 821, 822, 823, and 824 of the second block B₂.

Also, first, second, third, and fourth areas 831, 832, 833, and 834 are allocated for the N-th block B_{N} . The first area 831 stores data B_{(N-1)}_{_{—}}ₚᵣₑ regarding the (N−1)th block B_{N-1} equivalent to boundary data stored in the fourth area allocated to the (N−1)th block B_{N-1}, the second area 832 stores the main data of the N-th block B_{N}, and the third and fourth areas 833 and 834 are set with predetermined default values.

FIG. 9 is a flowchart illustrating a method of loading image data to perform image processing according to an exemplary embodiment of the present invention. Referring to FIG. 9, first, in operation 911, the overlap controller 160 or 650 determines a DMA-based transmission size and an overlap size according to the corresponding description with reference to FIG. 1. Then, in operation 912, the main data of each block of each line is loaded and stored in the second area 412 or 712 of the second storage unit 120 or 620.

In operation 913, it is determined whether the block loaded in operation 912 is the first block. If the loaded block is the first block, the method proceeds to operation 915. On the other hand, if the loaded block is not the first block, the method proceeds to operation 914, in which the first overlap data is loaded from the fourth area 714 of the second storage unit 620 or from the third storage unit 150 and stored in the first area 411 or 711 of the second storage unit 120 or 620. Thereafter, the method proceeds to operation 915.

In operation 915, it is determined whether the block loaded in operation 912 is the last block. If the loaded block is the last block, the method ends. On the other hand, if the loaded block is not the last block, the method proceeds to operation 916, in which the second overlap data is loaded from the first storage unit 110 or 610 and stored in the third area 413 or 713 of the second storage unit 120 or 620. Thereafter, the method ends.

The above-described exemplary embodiments of the present invention can also be embodied as computer readable codes written on a computer readable recording medium. The computer readable recording medium is any data storage device that can store data which can be read by a computer. Examples of the computer readable recording medium include read-only memory (ROM), random-access memory (RAM), CD-ROMs, magnetic tapes, floppy disks, optical data storage devices, and so on. Also, the computer readable codes can be transmitted via a carrier wave, such as data transmission through the Internet. The computer readable recording medium can also be distributed over network coupled computers so that the computer readable code is stored and executed in a distributed fashion. Also, functional programs, codes, and code segments for accomplishing the present invention can be easily construed by programmers skilled in the art to which the present invention pertains.

According to the present invention, image processing is performed on a current block using data stored in a small-capacity, high-speed memory for example, data resulting from image processing performed on the previous block and image data included in the next block. Hence, when original image data is divided into blocks, and image processing is performed on the divided blocks, seams between adjacent blocks do not appear.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A seamless image processing apparatus comprising:
a first storage unit storing original image data, the original image data including lines arranged in a vertical direction and blocks arranged in each of the lines in a horizontal direction, the block including main data; and
a signal processor processing the blocks, based on a digital memory access using the main data of a current block, first overlap data of a previous block and second overlap data of a next block so that no seams are generated at a boundary between adjacent blocks.

2. The seamless image processing apparatus of claim 1, wherein the signal processor comprises:
a second storage unit storing the main data and the first and second overlap data;
a digital memory access controller controlling transmission of the main data, and the first and second overlap data between the first and second storage units;
an image processor processing the main data and the first and second overlap data stored in the second storage unit and outputting processed data;
a third storage unit storing the processed data and using the processed data as the first overlap data for performing image processing on the next block; and
an overlap controller dividing the second storage unit into a plurality of areas and controlling the digital memory access controller and the image processor so that the original image data and the processed data are transmitted from the first and third storage units to the plurality of areas of the second storage unit.

3. The seamless image processing apparatus of claim 1, wherein the signal processor comprises:
a second storage unit storing the main data, the first and second overlap data, and processed data resulting from image processing of a current block;
a digital memory access controller controlling a transmission of original image data between the first and second storage units;
an image processor processing the main data of the current block and generating processed data and using the processed data as the first overlap data for performing image processing on the next block; and
an overlap controller dividing the second storage unit into a plurality of areas and controlling the digital memory access controller and the image processor so that the original image data is transmitted from the first storage unit to the plurality of areas of the second storage unit.

4. The seamless image processing apparatus of claim 1, wherein image processing is performed on the lines of the original image data in a sequence in which the lines are arranged, and image processing is performed on the blocks of each of the lines in a sequence in which the blocks are arranged.

5. The seamless image processing apparatus of claim 2, wherein the overlap controller divides the original image data into N blocks, wherein N depends on a capacity of the second storage unit.

6. The seamless image processing apparatus of claim 2, wherein the overlap controller determines a size of the first and second overlap data in each of the blocks depending on a type of image processing performed by the image processor.

7. The seamless image processing apparatus of claim 2, wherein, when the main data corresponding to the current block is stored in the second storage unit, the first overlap data corresponds to the previous block, and the second overlap data corresponds to the next block.

8. The seamless image processing apparatus of claim 2, wherein the second storage unit comprises:
a first area storing the first overlap data corresponding to the previous block;
a second area storing the main data corresponding to the current block; and
a third area storing the second overlap data corresponding to the next block.

9. The seamless image processing apparatus of claim 8, wherein if the current block is a first block, a first area is set with a default value.

10. The seamless image processing apparatus of claim 8, wherein if the current block is a last block, the third area and the third storage unit are set with default values.

11. The seamless image processing apparatus of claim 3, wherein the second storage unit comprises:
a first area storing the first overlap data corresponding to the previous block;
a second area storing the main data corresponding to the current block;
a third area storing the second overlap data corresponding to the next block; and
a fourth area storing processed data resulting from image processing of the current block and using the processed data as the first overlap for performing image processing on the next block.

12. The seamless image processing apparatus of claim 11, wherein if the current block is a first block, the first area is set with a default value.

13. The seamless image processing apparatus of claim 11, wherein if the current block is a last block, the third and fourth areas are set with default values.

14. A seamless image processing method comprising:
determining a transmission size based on a digital memory access and an overlap data size;
dividing original image data into N blocks according to the transmission size and the overlap data size and storing main data, first and second overlap data, and processed data resulting from image processing on a block-by-block basis, wherein the main data, the first and second overlap data, and the processed data correspond to each of the blocks; and
performing image processing on a current block using the main data and generating the first overlap data for a next block from the image processing of the current block.

15. The seamless image processing method of claim 14, wherein dividing the original image data comprises:
loading the main data of the current block among the original image data; and
loading at least one of the first and second overlap data depending on a location of the current block in each of the lines.

16. The seamless image processing method of claim 15, wherein loading of the at least one of the first and second overlap data comprises:
loading the second overlap data located close to the current block from the next block if the current block is the first block;
loading the first overlap data located close to the current block among data resulting from image processing on the previous block and second overlap data located close to the current block among the data included in the next block, if the current block is one of second through (N−1)th blocks; and
loading the first overlap data located close to the current block among the data resulting from image processing on the previous block if the current block is the N-th block.

17. The seamless image processing method of claim 14, wherein, image processing is performed on each of the lines of the original image data in a sequence in which the lines are arranged, and furthermore, image processing is performed on the individual blocks of each of the lines in a sequence in which the blocks are arranged.

18. The seamless image processing method of claim 14, wherein a size of the first and second overlap data in each of the blocks is determined according to a type of the image processing performed on the current block.

19. A computer-readable recording medium storing a program executing a seamless image processing method, the method comprising:
determining a transmission size based on a digital memory access and an overlap data size;
dividing original image data into N blocks according to the transmission size and the overlap data size and storing main data, first and second overlap data, and processed data resulting from image processing on a block-by-block basis, wherein the main data, the first and second overlap data, and the processed data correspond to each of the blocks; and
performing image processing on a current block using the main data, and the first and second overlap data and generating the processed data, the processed data used as the first overlap data for a next block.

20. An image processing apparatus comprising:
a first storage unit storing original image data, the original image data divided in blocks, including main data, arranged in a predetermined direction; and
a signal processor processing the blocks, based on a digital memory access using the main data of a current block, first overlap data of a previous block and second overlap data of a subsequent block so that no seams are generated at a boundary between adjacent blocks.

21. The apparatus of claim 20, wherein the signal processor comprises:
a second storage unit storing the main data and the first and second overlap data;
a digital memory access controller controlling transmission of the main, first, and second overlap data between the first and second storage units;
an image processor processing the main data and the first and second overlap data stored in the second storage unit and outputting processed data;
a third storage unit storing the processed data and using the processed data as the first overlap data for performing image processing of another subsequent block; and
an overlap controller dividing the second storage unit into a plurality of areas and controlling the digital memory access controller and the image processor so that the original image data and the processed data are transmitted from the first and third storage units to the plurality of areas of the second storage unit.

22. The apparatus of claim 20, wherein the signal processor comprises:
a second storage unit storing the main data of the current block, the first overlap data of the previous block and the second overlap data of the subsequent block, and processed data resulting from image processing of the current block;
a digital memory access controller controlling a transmission of the original image data, the main data, the first and second overlap data and the processed data between the first and second storage units;
an image processor processing the main data and the first and second overlap data stored in the second storage unit and generating the processed data and using the processed data as the first overlap data for performing image processing on another subsequent block; and
an overlap controller dividing the second storage unit into a plurality of areas and controlling the digital memory access controller and the image processor so that the original image data is transmitted from the first storage unit to the plurality of areas of the second storage unit.

23. The apparatus of claim 21, wherein the main data corresponds to the current block stored in the second storage unit, the first overlap data corresponds to the previous block, and the second overlap data corresponds to the subsequent block.

24. The apparatus of claim 22, wherein the main data corresponds to the current block stored in the second storage unit, the first overlap data corresponds to the previous block, and the second overlap data corresponds to the subsequent block.
